(19) United States
(12) Patent Application Publication
(10) Pub. No.: US 2004/0240719 A1
(43) Pub. Date: Dec. 2, 2004

(54) Method for producing images in spiral computed tomography, and a spiral CT unit

(76) Inventors: Achim Gruebnau, Bad Liebenzell (DE); Karl Stierstorfer, Erlangen (DE)

Correspondence Address: HARNESS, DICKEY & PIERCE, P.L.C., P.O.BOX 8910, RESTON, VA, 20195, US

(21) Appl. No.: 10/840,744

(22) Filed: May 7, 2004

(30) Foreign Application Priority Data
May 9, 2003 (DE) 10320882.8

(51) Int. Cl. G06K 9/00

(52) U.S. Cl. 382/131

(57) ABSTRACT

A method is for producing images in spiral computed tomography. For the purpose of calculating the tomographic images, incomplete intermediate images are calculated in an intermediate step. Further, use is made of an anisotropic sampling pattern adapted to the frequency content of the intermediate images in order to reduce the data input when calculating the intermediate images.

The present application hereby claims priority under 35 U.S.C. §119 on German patent application number DE 103 20 882.8 filed May 9, 2003, the entire contents of which are hereby incorporated herein by reference.

### FIELD OF THE INVENTION

The invention generally relates to a method for producing images in spiral computed tomography. Preferably, it relates to one, wherein:

in order to scan an object to be examined, preferably a patient, with the aid of at least one conical beam emanating from a focus, and with the aid of at least one planar detector, preferably of multirow design with a width orientated in the z-direction, for the purpose of detecting the at least one beam the at least one focus is moved around the object to be examined on a spiral focal track, the at least one detector supplying output data that correspond to the detected radiation,

incomplete intermediate images that lead to a data input are calculated, and

tomographic images are produced with the aid of the incomplete intermediate images.

### BACKGROUND OF THE INVENTION

A method, called the SMPR method (SMPR=segmented multiple plane reconstruction), is disclosed, for example, in the publication by Stierstorfer, Flohr, Bruder: Segmented Multiple Plane Reconstruction: A Novel Approximate Reconstruction Scheme for Multislice Spiral CT., Physics in Medicine and Biology, Vol. 47 (2002), pages 2571 to 2581, or by the German patent applications with references DE 101 27 269.3 and DE 101 33 237.8, respectively. A similar spiral CT unit is also known correspondingly from the above named documents.

By contrast with the conventional CT image conditioning methods, because of the multifarious production of incomplete intermediate images, these methods require large storage capacities in the image conditioning apparatus. Compression methods for reducing the required storage volume are known in principle from the field of computer graphics such as, for example, the compression of pixel-orientated image files as *.JPG or *.JPEG. However, these methods achieve only unsatisfactory compression factors for the CT images considered here.

### SUMMARY OF THE INVENTION

It is therefore an object of an embodiment of the invention to find an improved method for producing images in spiral computed tomography by which the high data input with reference to the incomplete intermediate images produced is reduced.

The inventors have realized that the structure of incomplete intermediate images in spiral CT, in particular in the case of the SMPR method, is endowed with a preferred direction with reference to its information density. Because of this preferred direction, it is possible to carry out a compression of the intermediate images with the aid of an anisotropic sampling pattern without the need to accept a reduction in the image information.

Consequently, the inventors propose that the method known per se for producing images in spiral computed tomography and comprising the following method steps, for example:

in order to scan an object to be examined, preferably a patient, with the aid of at least one conical beam emanating from a focus, and with the aid of at least one planar detector, preferably of multirow design with a width orientated in the z-direction, for the purpose of detecting the at least one beam the at least one focus is moved around the object to be examined on a spiral focal track, the at least one detector supplying output data that correspond to the detected radiation,

incomplete intermediate images that lead to a high data input are calculated, and

tomographic images are produced with the aid of the incomplete intermediate images,

be improved to the effect that an anisotropic sampling pattern is used to reduce the data input when calculating the intermediate images.

Incomplete intermediate images are to be understood within the sense of this application as including images that result from a partial back projection of beams, specifically only a fraction of 180°. Thus, they may be calculated from data records that do not contain a complete revolution (smaller than 180°) of the focus, and therefore also do not show a realistic representation of the object scanned.

In a preferred design of the method according to an embodiment of the invention, interpolation weighting functions that have been derived by fourier transformation of the original spectrum are used in the back interpolation from the non-Cartesian to the Cartesian image matrix.

Furthermore, the computational outlay can be reduced by carrying out a truncation (windowing) of the interpolation weighting function.

It can also correspond to the method according to an embodiment of the invention when the output data, pretreated if appropriate, are re-sorted (data rebinning) with reference to the beam geometry.

In this method, it is advantageous for the calculation of the incomplete intermediate images to be performed by filtering projections and by back projection, for example in accordance with the known SMPR method.

In order to produce the tomographic images, in data rebinning the output data can be converted from data records in beam geometry to data records in parallel geometry. Alternatively, however, the tomographic images can also be produced directly from the fan data.

Intermediate images are advantageously calculated from the data of a spiral angle segment smaller than 180° with reference to the revolution of the focus, the size of a spiral angle segment preferably being 180°/n with n equal to 16 to 24. The intermediate images further form segment stacks in the case of which the number of the images is preferably equal to the number of detector rows.

Moreover, the segment stacks can be reformatted to form segment images, and the complete tomographic images can be produced by adding segment images.

In accordance with the basic idea of an embodiment of the invention, the inventors also propose a spiral CT for producing tomographic images having at least one x-ray source, a detector and an image conditioning apparatus for calculating the tomographic images, which has preferably at least one processor with memory and programming, for carrying out the method according to an embodiment of the invention.

### BRIEF DESCRIPTION OF THE DRAWINGS

An embodiment of the invention is explained in more detail below with reference to the SMPR method, used by way of example, and with the aid of the figures, the following reference symbols being used in the figures with the meaning specified: 1: gantry; 2: focus; 3: beam diaphragm; 4: beam; 5: detector; 6: data/control line; 7: computer; 8: monitor; 9: keyboard; 10: intermediate image; 11: pixel; 12.n: segment stack; 13.n: segment images; 14: tomographic image; 15: butterfly filter; 16: origin; 17: modified butterfly filter; B: width of the detector; L: length of the detector; P: patient; P₁-Pₙ: program module; S: spiral track; V: feed;

\vec{u}ₓ, \vec{u}_{y}: periodicity vectors in the spatial frequency domain;

\vec{v}ₓ, \vec{v}_{y} periodicity vectors in the spatial domain; α: segment angle; β: fan angle of the beam; φ: cone angle of the beam; ωₐ: filter boundary in the ωₓ direction; ω_{b}: filter boundary in the ω_{y} direction; ωₓ: frequency vector in the x-direction; ω_{y}: frequency vector in the y-direction.

In detail:

FIG. 1 shows a schematic in the z-direction of a spiral CT unit having several rows of detector elements;

FIG. 2 shows a longitudinal section along the z-axis through the unit in accordance with FIG. 1;

FIG. 3 shows a schematic of the spiral movement of focus and detector;

FIG. 4 shows a position of intermediate images for the SMPR algorithm along the spiral focal track split up into six segments;

FIG. 5 shows the addition of segment images to form the final tomographic image;

FIG. 6 shows the spectrum of an intermediate image from Fourier-transformed projections from a segment angle;

FIG. 7 shows estimation of the juxtaposition of the frequency spectra of the discretized signal;

FIG. 8 shows the effect of the juxtaposition of the frequency spectra on the sampling pattern;

FIG. 9 shows a further possibility of a periodicity pattern without overlapping spectra;

FIG. 10 shows sampling patterns relating to the periodicity pattern;

FIG. 11 shows spectra packed with optimum density;

FIG. 12 shows sampling patterns relating to spectra packed with optimum density;

FIG. 13 shows butterfly filters in the frequency domain after windowing in the spatial domain with the aid of a cos² window; and

FIG. 14 shows modified butterfly filters.

### DETAILED DESCRIPTION OF THE PREFERRED EMBODIMENTS

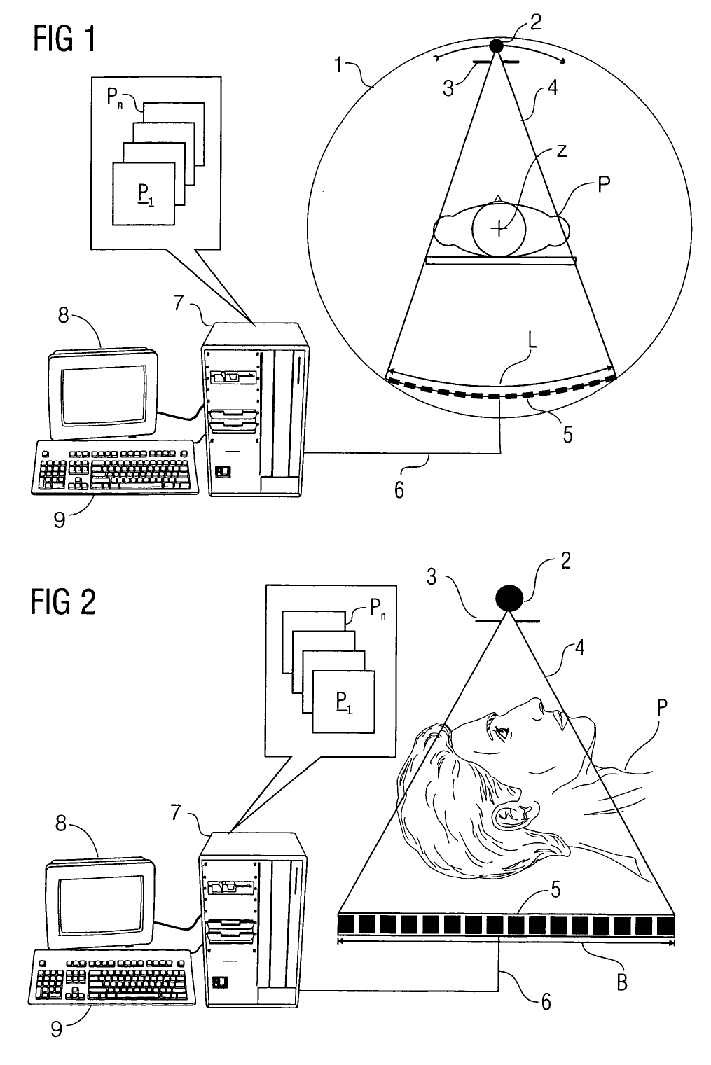

A spiral CT unit suitable for carrying out the method according to an embodiment of the invention and having a multirow detector is illustrated in FIGS. 1 and 2. FIG. 1 shows in a schematic the gantry 1 with a focus 2 and a likewise rotating detector 5 in a section perpendicular to the z-axis, while FIG. 2 shows a longitudinal section in the direction of the z-axis. The gantry 1 has an x-ray source with its schematically illustrated focus 2 and a beam diaphragm 3 near the source and mounted in front of the focus.

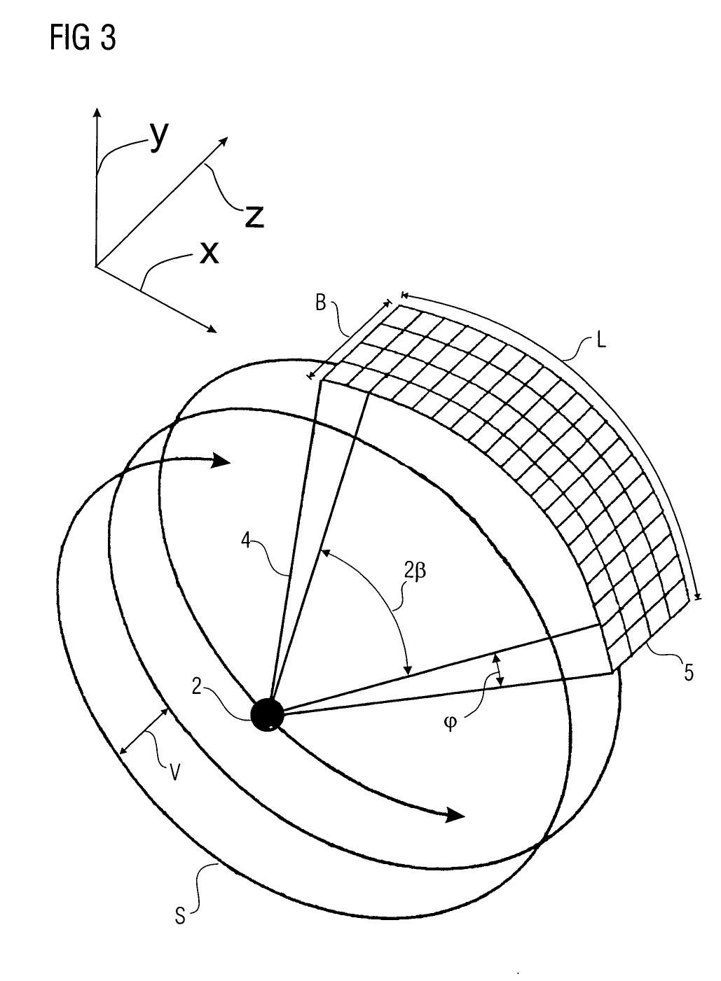

Starting from the focus 2, a fan-shaped beam 4 runs in a fashion delimited by the beam diaphragm 3 to the detector 5 situated opposite, which beam penetrates the patient P lying there between. The detector has a length L and a width B. The fan angle of the beam 4 is denoted by 2β, and the cone angle is denoted by φ. The scanning is performed during the rotation of the focus 2 and detector 5 about the z-axis, the patient P being moved at the same time in the direction of the z-axis. This gives rise in the coordinate system of the patient P to a spiral track S for the focus 2 and detector 5 with a pitch or feed V as illustrated spatially and schematically in FIG. 3.

When scanning the patient P, the dose-dependent signals detected by the detector 5 are transmitted to the computer 7 via the data/control line 6. The spatial structure of the scanned region of the patient P is subsequently calculated in terms of its absorption values from the measured raw data with the aid of known methods that are stored in the illustrated program modules P₁ to Pₙ. According to an embodiment of the invention, it is possible to use all known 2D as well as 3D reconstruction methods in so doing, although it is common to all the methods that a weighting of the data is undertaken over the width B of the detector 5.

The remaining operation and control of the CT unit is likewise performed by means of the computer 7 and the keyboard 9. The calculated data can be output via the monitor 8 or a printer (not illustrated).

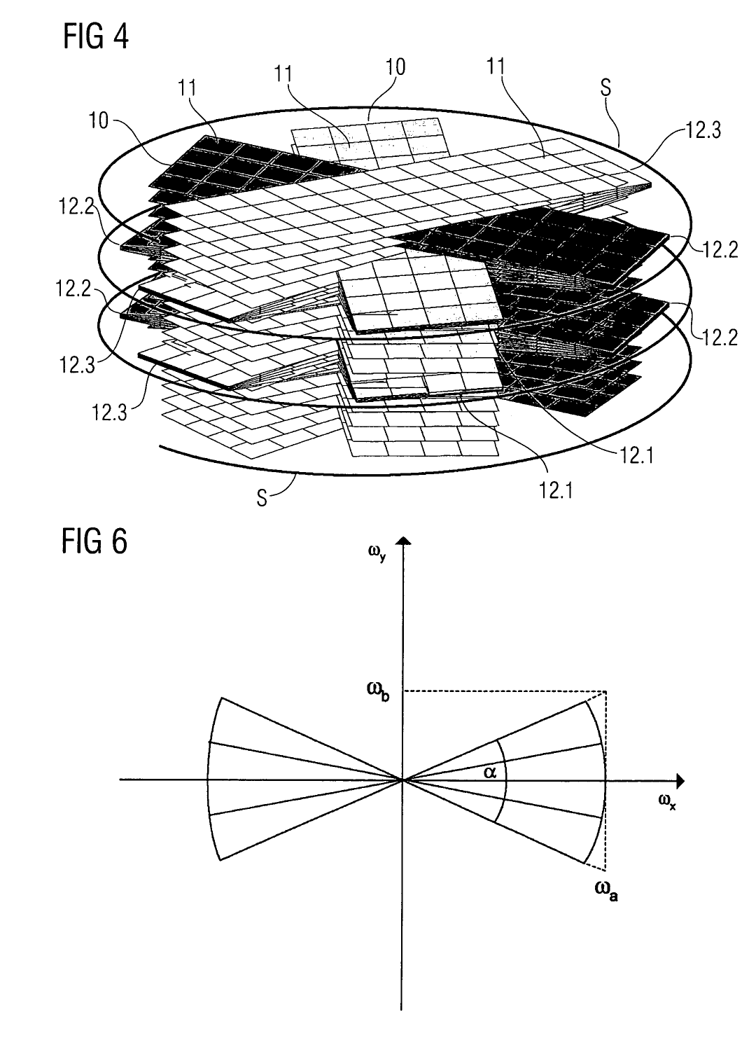

The CT apparatus shown in FIGS. 1 to 3 thus corresponds to spiral CT units known in image conditioning, with the exception of the program modules according to an embodiment of the invention. The implementation of an embodiment of the invention is thus to be found in these program modules. With the aid of FIGS. 4 to 14, the theoretical background of the method according to an embodiment of the invention, and its implementation, will now be explained for the special case of the SMPR method (SMPR=segmented multiple plane reconstruction) known per se. Reference may be made as regards this method to the document of Stierstorfer, Flohr, Bruder: Segmented Multiple Plane Reconstruction: A Novel Approximate Reconstruction Scheme for Multislice Spiral CT., Physics in Medicine and Biology, Vol. 47 (2002), pages 2571-2581, the entire contents of which are hereby incorporated herein by reference.

This SMPR method divides the path from the recording of measured values up to image calculation into four sections, namely: data rebinning, calculation of intermediate images by filtering projections and back projection, reformatting segment stacks into segment images, and adding segment images.

The first step in the SMPR method is to produce incomplete intermediate images on inclined planes adapted to the spirals, as is illustrated in FIG. 4. These images are incomplete because they result from the back projection of a short subsegment of the spirals. A large number of these intermediate images are required (typically approximately 1000 per revolution). The particular nature of these images as incomplete images and, in conjunction therewith; their frequency content permit a substantial data reduction, however.

In the SMPR method, it is not only one intermediate image that is calculated for an angle segment, but, as stipulated, a number of images that are denoted in common as a segment stack 12. The associated intermediate images 10 of a segment stack 12.n are shaded identically in FIG. 4. By way of example, typical values for the number of angle segments and the number of the calculated intermediate images of an angle segment are 16-24 angle segments for Nz intermediate images per segment stack, Nz being, for example, the number of the detector rows.

Reformatting segment stacks into segment images:

The intermediate images 10 of a segment stack 12.n are not necessarily orthogonal to the z-axis of the scanner in the measurement volume. In the reformatting process, the pixels of the intermediate images are interpolated onto a transversely situated, virtual plane and yield the segment images relating to a specific z-position. The z-position of the virtual planar section is freely selectable in principle. The weighting of the individual pixels of the numerous intermediate images inclined in space is carried out by means of a distance weighting function in the z-direction, weighting with the aid of a triangular function having proved to be sufficient.

The reformatting step is carried out for a specific spiral angle segment and its opposite segment, resulting in a planar segment image on the virtual planar section. Although the intermediate images of the complementary spiral angle segment differ in the z-position of the direct segment by the amount of half a pitch, because of the spiral geometry, the feed V in the z-direction is not so large that the distance weighting function no longer acquires the intermediate images of the complementary segment. Thus, the reformatting process ends with the result that half as many segment images as spiral angle segments are present per z-position.

Addition of segment images:

In a last step, the individual segment images must further be added up so that a tomographic image is available that can be used for diagnostic purposes. FIG. 5 shows the schematic of such an addition process in which the segment images 13 determined from the intermediate images 10 of FIG. 4 have been added up to form the tomographic image 14.

As may be seen from the SMPR method set forth above, when it is carried out large data volumes arise in the storage of the intermediate images. For a typical value of 24 segments, by contrast with conventional AMPR methods (AMPR=advanced multiple plane reconstruction) a data volume arises that is increased by the factor of 24 and has to be buffered temporarily. This is where an embodiment of the present invention steps in and permits a skillful data compression without substantial loss of information.

The essential basic idea leading to a reduction in data volume may best be explained by considering the frequency spectrum of an intermediate image. The derivation of the known Fourier slice theorem can be used to make a statement as to how the spectrum, on the one hand, and the image impression, on the other hand, change when not all the raw data from a full tube revolution are available. Expressed in a somewhat simplified manner, the theorem says that the two-dimensional Fourier spectrum of an image can be obtained by individually subjecting all the projections from the region of the solid angle to Fourier transformation, and again plotting them in the frequency domain at the projection angle.

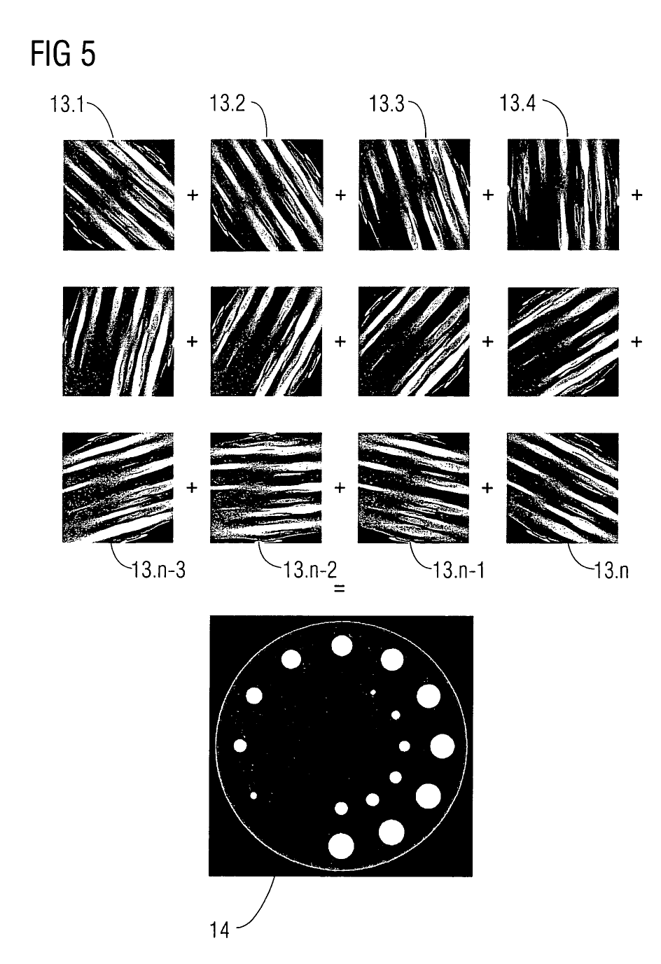

If projections are missing from specific angle regions, the frequency plane is likewise not completely covered with projections subjected to Fourier transformation. This idea is explained once more in FIG. 6. Clearly, such a spectrum is narrower in one coordinate direction than in the other. It is known that a signal can be precisely reconstructed whenever the spectra of the discreted signal do not overlap. The mutual overlapping is also further prevented, however, whenever the spectra are more closely juxtaposed because of their anisotropic circumference.

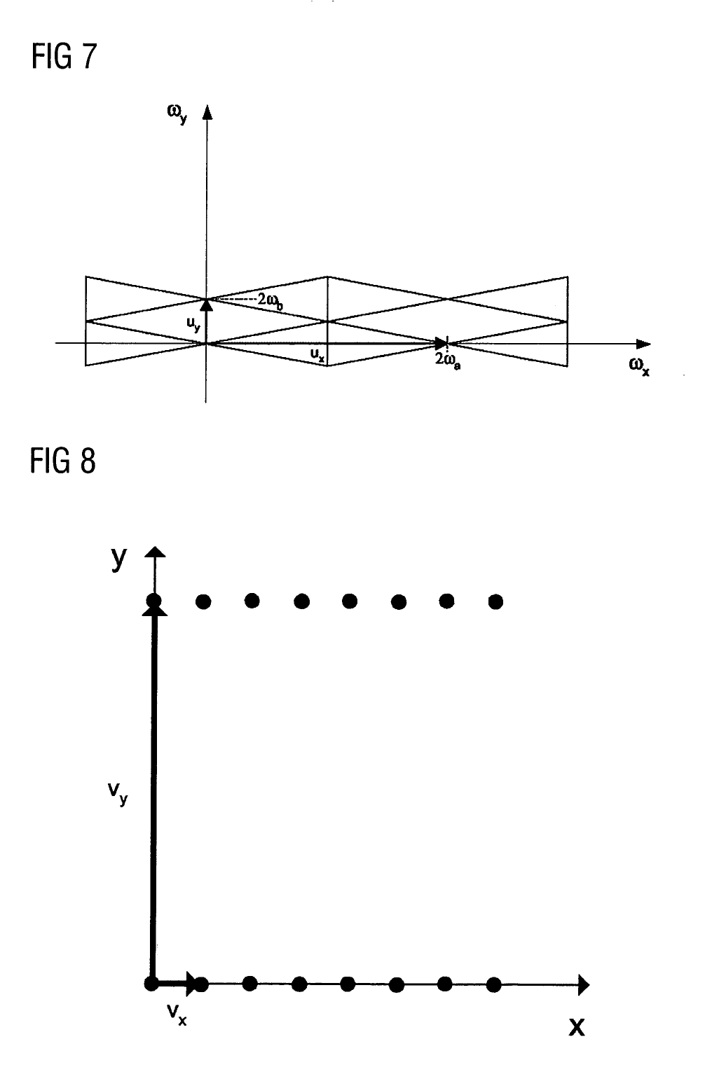

The particular shape of the spectrum in FIG. 6, including two triangles joined at the apex (“butterfly-shaped”); permits the spectra to be arranged without overlapping—as indicated in FIG. 7. As set forth below, a non-Cartesian sampling pattern corresponds to this in the spatial domain. Reference may be made for this purpose to the publication by Dudgeon, Mersereau, Multidimensional Digital Signal Processing, Englewood Cliffs, N.J., Prentice-Hall, 1984, the entire contents of which are hereby incorporated herein by reference.

The following equation describes the interconnection of the sampling matrix and periodicity matrix:

U′V=2πI

This equation may be used to specify in detail how the juxtaposition of the spectra in the frequency domain affects the sampling matrix, and thus also the sampling pattern. In order to permit efficient estimates, the equation is recast in terms of U and V such that statements can be made in each case for stipulations in the spatial and frequency domains, and it holds that:

$$\begin{matrix}V = ( \begin{matrix}{v}_{11} & {v}_{12} \\ {v}_{21} & {v}_{22}\end{matrix} ) = \frac{2 π}{{u}_{11} {u}_{22} - {u}_{21} {u}_{12}} ( \begin{matrix}{u}_{22} & - {u}_{21} \\ - {u}_{12} & {u}_{11}\end{matrix} ) \\ U = ( \begin{matrix}{u}_{11} & {u}_{12} \\ {u}_{21} & {u}_{22}\end{matrix} ) = \frac{2 π}{{v}_{11} {v}_{22} - {v}_{21} {v}_{12}} ( \begin{matrix}{v}_{22} & - {v}_{21} \\ - {v}_{12} & {v}_{11}\end{matrix} )\end{matrix}$$

In a first assumption, it is assumed that the spectra as indicated in FIGS. 7 and 8 are arranged precisely such that their frequency maxima do not intersect. The spectra are repeated in the ωₓ-direction with k2ωₐ, and in the ωₓ-direction with k2ω_{b}, kεN. The length of the periodicity vector \vec{u}_{y} in the ω_{y}-direction is shortened by a factor c:

$$U = ( {{u}^{->}}_{x} \vert {{u}^{->}}_{y} ) = ( \begin{matrix}2 {ω}_{a} & 0 \\ 0 & \frac{2 \text{?}}{c}\end{matrix} )$$

$$\text{?} \text{indicates text missing or illegible when filed}$$

the result being that:

$$V = π ( \begin{matrix}\frac{1}{{ω}_{a}} & 0 \\ 0 & \text{?}\end{matrix} )$$

$$\text{?} \text{indicates text missing or illegible when filed}$$

The values of the sampling vector \vec{v}_{y} in this case occupy the right-hand column of the matrix. It is immediately apparent that the direction of the vector has not been changed by the introduction of the factor c, although the length certainly has, having been enlarged by the factor c. According to this estimation, there is thus an inversely proportional relationship between the length of the periodicity vector \vec{u}_{y} and the length of the sampling vector \vec{v}_{y}, as may be seen in FIGS. 7 and 8. Thus, it is possible to retain a Cartesian sampling pattern. All that need be done is to widen the spacing of the samples in the y-direction.

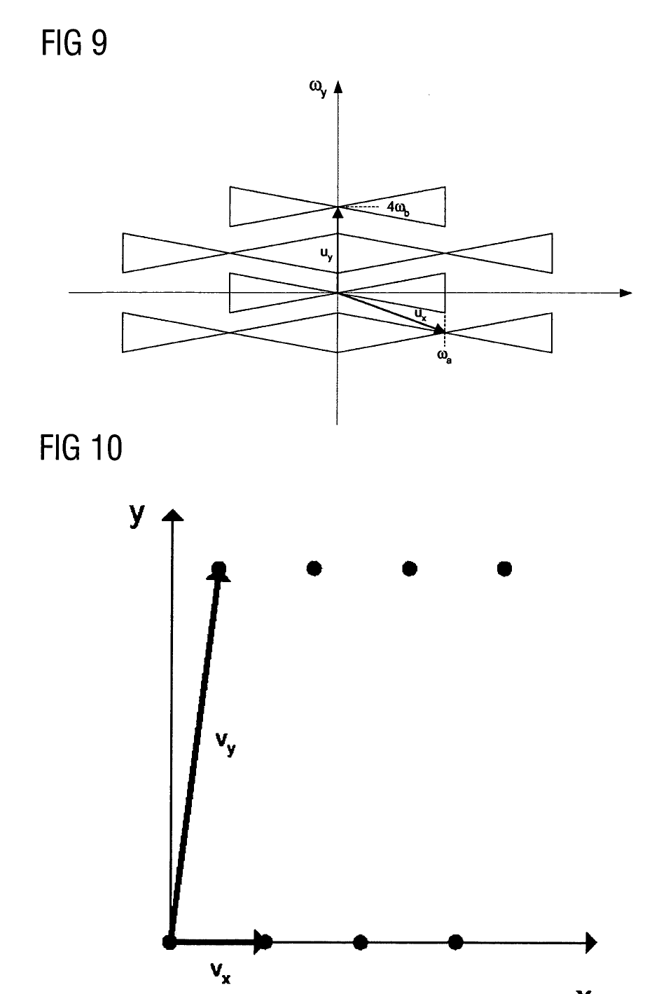

The frequency spectra can also be arranged in the frequency plane by use of a different periodicity pattern. In fact, there are infinitely many possibilities, since no restrictions apply to the selection of the sampling pattern. Thus, for example, the periodicity pattern shown in FIGS. 9 and 10 is also possible. Considering the spectra as being arranged in rows in the x-direction, the difference by comparison with the pattern in FIGS. 7 and 8 resides in the fact that each second “spectra line” is displaced by the value ωₐ. This has the following effect in the periodicity matrix and in the sampling matrix:

$$\begin{matrix}U = ( \begin{matrix}{ω}_{a} & 0 \\ - 2 {ω}_{b} & 4 {ω}_{b}\end{matrix} ) \\ V = π ( \begin{matrix}\frac{2}{{ω}_{a}} & \frac{c}{{ω}_{a}} \\ 0 & \frac{c}{2 {ω}_{b}}\end{matrix} )\end{matrix}$$

The sampling pattern associated with the last equation is illustrated in FIGS. 9 and 10. The shifting of each second spectrum “line” thus effects a non-Cartesian sampling pattern. By comparison with the sampling pattern of FIGS. 7 and 8, it is to be seen, in addition, that the number of samples required per planar unit does not vary. The number of samples in the x-direction is halved, but the number of samples in the y-direction is doubled, as may also easily be read from the sampling matrix. The shifting of the spectra therefore does not effect a denser packing. FIGS. 9 and 10 do, however, indicate the possibility of a denser packing of the spectra, all that is required being to execute a further step of shrinking the periodicity vector \vec{U}_{y}.

If a perfect reconstruction of the signal is desired, it suffices to require that the sampling pattern be restricted so that its selection does not lead to overlapping spectra.

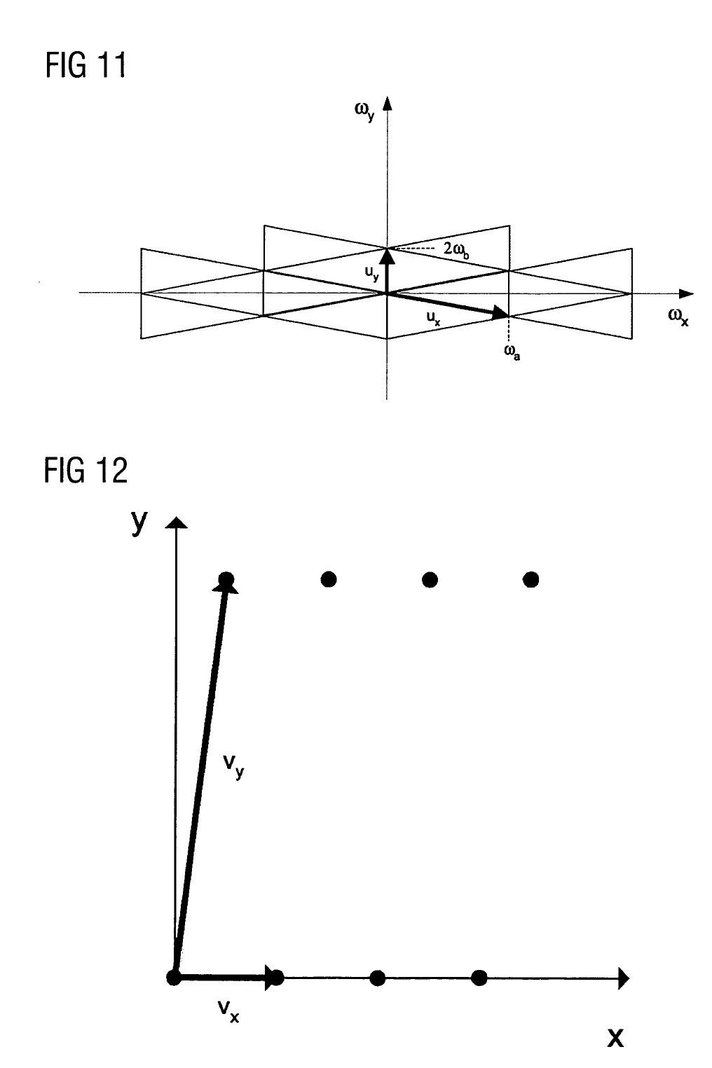

The result is a frequency plane as indicated in FIG. 11, in which the spectra are packed in an optimally dense fashion without resulting in intersections of the frequency bands. The associated sampling pattern is illustrated in FIG. 12. The result once again is a non-Cartesian pattern. In comparison with the pattern from FIGS. 9 and 10, which is based on a periodicity pattern with spectra that are not shifted in each second line, it is to be seen that the sample spacings have been doubled in the x-direction, while the spacings in the y-direction remain unchanged.

Thus, owing to the packing with optimum density, in addition to a reduction in the number of samples by the factor c it is therefore possible to achieve a minimization by a factor of two. The relationships are also to be seen from the consideration of sampling and periodicity matrices. It holds that:

$$\begin{matrix}U = ( \begin{matrix}{ω}_{a} & 0 \\ - {ω}_{b} & 2 {ω}_{b}\end{matrix} ) \\ V = π ( \begin{matrix}\frac{2}{{ω}_{a}} & \frac{c}{{ω}_{a}} \\ 0 & \frac{c}{{ω}_{b}}\end{matrix} )\end{matrix}$$

All the considerations of the estimation assume, however, that an intermediate image has the frequency content in the shape of butterfly wings as shown in FIG. 6. If this assumption does not apply, it is necessary to deal with aliasing artifacts, particularly in the case of the packing that is optimally most dense.

The utilization of the shape of the spectrum according to FIG. 6 permits the discrete representation of a continuous signal with fewer samples than in the case of a circularly band-limited signal. A compression has been presented above that although permitting a Cartesian sampling pattern that is easy to handle does not constitute the theoretical optimum. The last example exhibits the best possible sampling pattern for compression purposes, the price of this being a certain outlay on reprocessing. The non-Cartesian sampling pattern forces a back interpolation onto a Cartesian grid, since the entire subsequent image processing chain such as, for example, subsequent image processing algorithms, printers or display screens is tuned to such a grid.

A reinterpolation to a normal Cartesian grid is required at the latest when combining the partial images to form a complete image. An interpolation method adapted to the spectrum has to be applied in this case in order to avoid aliasing artifacts. In the case of one-dimensional sampling, the ideal case would be sinc-interpolation that masks out an exactly overlap-free rectangular window in the frequency domain.

This can no longer be achieved in the case of the optimally densely packed spectrum from the last estimate (FIGS. 11 and 12). In this case, there is actually a need for a filter that, with the shape of the main spectrum, masks out precisely the main spectrum and does not pass frequencies of the secondary spectra. According to the system theory, it is possible to interpolate to a Cartesian grid by using the continuous filter function to subject the samples obtained in a non-Cartesian fashion to convolution. In order to facilitate the terminological handling, the filter may be denoted by butterfly filter below because of its shape.

It may now be further explained how a specific sampling pattern is defined within the meaning of this application. The lengthening of the pixels in the direction of the coordinate axes is determined by two parameters, which may here be called facx and facy. The selection of facₓ=1, fac_{y}=8 means that the pixels remain unchanged in the x-direction, or the sample spacings remain unchanged in the x-direction, whereas the sample spacings in the y-direction are enlarged by a factor of eight. If facₓ=2 and fac_{y}=8 are selected, an arrangement of sampling and periodicity matrices then remains as in FIGS. 11 and 12, a number of 24 segments being presupposed.

However, this configuration makes sense only for a non-Cartesian sampling pattern. Thus, it is further necessary to place a flag that activates the sample offset in the x-direction in the back projection routine, and thus the non-Cartesian sampling pattern. Only when facx, facy and the flag for activating a non-Cartesian sampling pattern are known is the sampling pattern determined exactly.

Starting from FIG. 6, it is possible to make a statement concerning the functional dependency of compression factor and number of segments. Let a be the segment angle and N_{seg} be the number of segments, in which case it holds that

$$α = \frac{2 π}{{N}_{seg}}$$

However, it also holds that

$$tan ( \frac{α}{2} ) = \frac{{ω}_{b}}{{ω}_{a}}$$

the quotient

$$\frac{{ω}_{b}}{{ω}_{a}}$$

being a measure of the compressibility. The tangent function is approximately linear for small segment angles α, and so there is an approximately linear relationship between the number of segments and the compression factor. With N_{seg}=24 the compression factor is calculated as

$$tan [ \frac{\frac{2 π}{24}}{2} ] \approx 0.131$$

Forming the reciprocal yields a possible lengthening of the pixels in the y-direction of approximately 7.59. The next largest whole number is selected for practical reasons.

The filter explained above has a disadvantageous property in the spatial domain: its function values tend to zero only slowly with distance from the origin. This is not bad, in theory, since the carrier of the filter function is theoretically infinitely large. However, conducting the convolution in practice in a computer requires a limitation on the number of the values that represent the filter discretely.

Consequently, the filter function is truncated in practice, and so the theory of perfect reconstruction is abandoned. Truncating a filter function at points at which values which are actually still relevant are no longer taken into account owing to the slow decay of the filter function values amounts to a multiplication with the aid of a rectangular filter in the spatial domain. The multiplication in the spatial domain corresponds in the frequency domain to a convolution of the filter with the aid of a sinc function in the frequency domain, with the result that the form of the filter is changed, and the filter no longer has the desired filter characteristic.

By comparison with other interpolation filters, filters truncated in the spatial domain and having an infinite carrier and slow decay truncate their values badly. However, the effects of the truncation can be mitigated by multiplication with a window other than a rectangular one, such as a cos₂ window, for example. The changes in the filter shape in the frequency domain are then not so serious as in the case of pure truncation. However, since the finite representation of the filter in the computer already amounts in itself to a truncation whether windowed with the aid of a “soft” window or not, it is always necessary to accept a deviation of the filter in the frequency domain from its desired form.

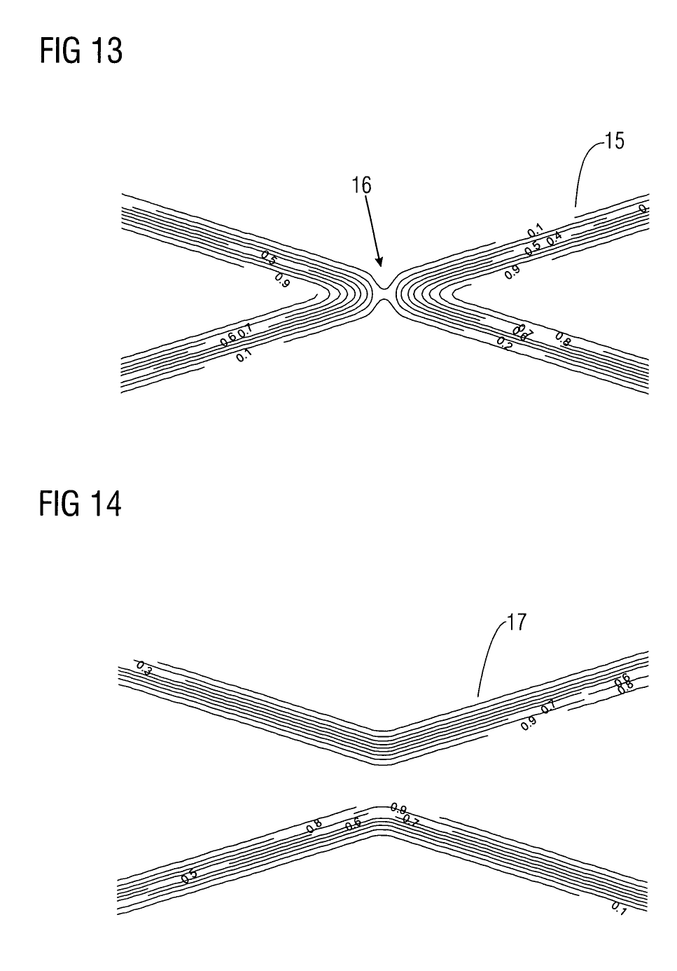

These deviations are seen, inter alia, in that overshoots are formed at the edges of the filter, and wavy distortions are formed in the regions without edges. These influences do not necessarily have a severe effect on an ideal 2D lowpass filter (rectangular filter). However, the butterfly filter 15 as illustrated in FIG. 13 exhibits a critical behavior through its narrow form in the vicinity of the origin when it is convoluted in the frequency domain with the aid of the Fourier transform of the window function, of whatever nature, from the spatial domain.

If the butterfly filter is considered to be in three-dimensional entity, its “substance” is very thin in the vicinity of the origin when expressed pictorially, and is limited at the origin itself to only an infinitesimally small point. A convolution of the filter at the origin 16 will change the actually desired gain from the magnitude of one. However, this has the fatal significance that the back-reconstructed function has a changed zero-frequency component, and this has a very negative effect on the image impression. FIG. 13 shows the spatial representation of the butterfly filter 15 with the aid of potential lines, calculated by applying a discrete Fourier transform to previously sampled filter values. The intrusion in the filter shape at the origin 16 is clearly in evidence.

The remedy is provided here by expanding the filter shape in the vicinity of the origin 16 in such a way that even after the windowing the zero-frequency component is not substantially changed in the frequency domain. FIG. 14 shows such an expanded butterfly filter 17 with changed cutoff frequencies, which is called a modified butterfly filter for short.

Note that the butterfly filters 15 and 17 illustrated in FIGS. 13 and 14 by potential planes in each case have numerical values that describe the potentials or filter values of the filters.

A consideration of the filter windowed in the spatial domain is performed in the frequency domain by analogy with the original butterfly filter. Influencing of the frequency at the origin, that is to say of the zero-frequency component, is no longer substantial. The expansion of the interpolation filter about the origin will be made as narrow as possible, on the one hand, and as wide as necessary, on the other hand. However, the expansion leads to a no longer optimum packing density of the spectra, since the expanded geometry no longer permits a conclusive and tight fit. Thus, only the modified butterfly filter is to be classified as suitable for practical use.

A further important point of the back interpolation to a Cartesian grid is the concrete selection of the filter boundaries ωₐ and ω_{b}. ωₐ and ω_{b} follow from the requirement that, in accordance with FIG. 6, on the one hand the original spectrum is to remain as far as possible untouched by the filtering, and on the other hand the filter function is to be as narrow as possible in order to avoid aliasing.

Data compression can be used only at very specific points of an SMPR method. Data rebinning and filtering of projections are not detected by the data compression, and it is not until the back projection, in which the measured values are converted into 2D images, that compression methods can be used and run through the concept thereof up to the last step of the addition of the segment images.

The transposed pixel matrix can be produced directly for the back projection, since individual pixels can be produced at any desired locations during back projection. In order to bring the mean back projection direction and the image matrix into congruent, the mean projection direction should be rotated onto an image axis (for example the east/west axis). Thus, the images must be appropriately rotated in the course of being combined into complete images. If direct and complementary angle segments are jointly reformatted during the reformatting, it must be ensured that the pixel positions for direct and complementary segments also correspond in the case of a transposed pixel matrix.

The reformatting can be carried out on the reduced images pixel by pixel, exactly as described above.

Half as many segment images as spiral segments are present at the end of the reformatting process. The halving results from the simultaneous reformatting of direct and complementary segments. In the last step, these (now compressed) segment images must be added to form a complete image. It must be taken into account in this process that the images have been produced with a fixed back projection angle, that is to say there is a need for further rotation before the addition. Thus the images must be rotated before the addition and interpolated upon the final pixel matrix. This can advantageously take place in one step: the original rotated, reduced (and transposed, if appropriate) pixel matrix then supplies the interpolation points for the interpolation onto the final grid.

As described above, in order to avoid aliasing the interpolation should in this case expediently be performed for non-Cartesian sampling, using the butterfly filter or a similar filter.

Thus, this application proposes a method for reducing the data volume during spiral CT image calculation with the aid of partially back-projected images, in particular when use is made of the SMPR reconstruction algorithm. This algorithm permits the calculation of CT images with significantly improved suppression of cone beam artifacts, and this comes to bear particularly with an increased number of detector rows. The price for the reduced occurrence of cone beam artifacts is a substantially increased number of intermediate images that have to be produced temporarily in order to calculate a final tomographic image. It is therefore desirable to reduce the data volume occurring during the calculation of intermediate images.

At least in the case of the SMPR algorithm, these intermediate images have a specific characteristic that supplies the basis for data compression. The spectra have a shape that recalls a pair of butterfly wings, and in addition is also compressed in a frequency direction. Consequently, the information contained in the intermediate images can be represented with the aid of fewer sampling points than in the case of an image with a rotationally symmetrical spectrum. If, in addition, a non-Cartesian sampling pattern is selected, sampling points can once again be spared in addition.

An interesting characteristic, which is also to be assessed as positive of the data compression presented is the simultaneous reduction in data input and in the computer time required for calculating the image data. Compression methods such as the JPEG or MPEG format certainly achieve higher compression rates in general, but because of the decoding and encoding processes required necessitate not inconsiderable computing powers, and cannot guarantee the image quality.

A storage medium may be adapted to store programming information and adapted to interact with a computer device or processor to perform the method of any of the above mentioned embodiments. The storage medium can be in the form of a computer-readable storage medium. The storage medium may be a built-in medium installed inside a computer main body or removable medium arranged so that it can be separated from the computer main body. Examples of the built-in medium include, but are not limited to, rewriteable involatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable involatile memory, such as memory cards; and media with a built-in ROM, such as ROM cassettes.

It goes without saying that the above-named features of the invention can be used not only in the combination respectively specified, but also in other combinations or on their own, without departing from the scope of the invention.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for producing images in spiral computed tomography, comprising:
scanning an object to be examined with at least one conical beam;
detecting the at least one beam and supplying output data that correspond to detected radiation;
calculating incomplete intermediate images; and
producing tomographic images using calculated the incomplete intermediate images, wherein to reduce data input when calculating the intermediate images, an anisotropic sampling pattern, with pixels offset by at least one of a row and column, is used in a fashion adapted to a frequency content of the intermediate images.

2. The method as claimed in claim 1, wherein back interpolation to a Cartesian image matrix is carried out with the aid of interpolation weighting functions that have been derived by Fourier transformation of the original spectrum.

3. The method as claimed in claim 2, wherein computational outlay is reduced by truncating the interpolation weighting function.

4. The method as claimed in claim 1, wherein the output data, pretreated if appropriate, are re-sorted with reference to beam geometry.

5. The method as claimed in claim 1, wherein the calculation of the incomplete intermediate images is performed by filtering projections and by back projection.

6. The method as claimed in claim 4, wherein in the data resorting, the output data are converted from data records in beam geometry to data records in parallel geometry.

7. The method as claimed in claim 4, wherein, in the data resorting, the output data are converted from data records in beam geometry to data records in parallel geometry in order to produce the tomographic images.

8. The method as claimed in claim 17, wherein the intermediate images are calculated from the data of spiral angle segments smaller than 180° of the revolution of the focus.

9. The method as claimed in claim 8, wherein the size of a spiral angle segment is 180°/n, with n equal to 16 to 24.

10. The method as claimed in claim 1, wherein the intermediate images form segment stacks.

11. The method as claimed in claim 10, wherein the segment stacks are reformatted to form segment images.

12. The method as claimed in claim 11, wherein the tomographic images are produced by adding segment images.

13. Spiral CT for producing tomographic images, comprising:
at least one x-ray source;
a detector; and
an image conditioning apparatus for calculating the tomographic images, the image conditioning apparatus including means for carrying out the producing step as claimed in claim 1.

14. The method as claimed in claim 1, wherein the object to be examined is a patient.

15. The method as claimed in claim 1, wherein the detecting is performed with the aid of at least one planar detector.

16. The method as claimed in claim 15, wherein the detector is of a multirow design with a width orientated in the z-direction.

17. The method as claimed in claim 1, wherein the scanning of the object is performed with the aid of at least one conical beam emanating from a focus.

18. The method as claimed in claim 17, wherein the focus is moved around the object to be examined on a spiral focal track.

19. The method as claimed in claim 1, wherein the scanning of the object is performed with the aid of at least one conical beam emanating from a focus, the focus being moved around the object.

20. The method as claimed in claim 2, wherein the calculation of the incomplete intermediate images is performed by filtering projections and by back projection.

21. The method as claimed in claim 15, wherein the intermediate images form segment stacks with Nz=24 to 48 intermediate images per segment stack, Nz being a number of detector rows.

22. The method as claimed in claim 21, wherein the segment stacks are reformatted to form segment images.

23. The method as claimed in claim 22, wherein the tomographic images are produced by adding segment images.

24. The method as claimed in claim 16, wherein the intermediate images form segment stacks with Nz=24 to 48 intermediate images per segment stack, Nz being a number of detector rows.

25. The method as claimed in claim 24, wherein the segment stacks are reformatted to form segment images.

26. The method as claimed in claim 25, wherein the tomographic images are produced by adding segment images.

27. The method as claimed in claim 19, wherein the intermediate images are calculated from the data of spiral angle segments smaller than 180° of the revolution of the focus.

28. The method as claimed in claim 27, wherein the size of a spiral angle segment is 180°/n, with n equal to 16 to 24.

29. A spiral computed tomography device for producing tomographic images, comprising:
at least one x-ray source;
a detector; and
an image conditioning apparatus, adapted to calculate incomplete intermediate images that lead to a data input and adapted to produce the tomographic images using calculated the incomplete intermediate images, wherein to reduce data input when calculating the intermediate images, an anisotropic sampling pattern, with pixels offset by at least one of a row and column, is used in a fashion adapted to a frequency content of the intermediate images.

30. A device for producing images in spiral computed tomography, comprising:
means for scanning an object to be examined with at least one conical beam;
means for detecting the at least one beam and supplying output data that correspond to detected radiation;
means for calculating incomplete intermediate images that lead to a data input; and
means for producing tomographic images using calculated the incomplete intermediate images, wherein to reduce data input when calculating the intermediate images, an anisotropic sampling pattern, with pixels offset by at least one of a row and column, is used in a fashion adapted to a frequency content of the intermediate images.

31. The device of claim 30, wherein at least one of the means for calculating and the means for producing includes a program which, when executed by a computer device, is adapted to perform at least one of the calculating and producing.

32. The device of claim 30, wherein the program is stored on a computer readable medium.

33. A method for producing images in spiral computed tomography from radiation detected from an object scanned with at least one conical beam, the method comprising:
calculating incomplete intermediate images; and
producing tomographic images using calculated the incomplete intermediate images, wherein to reduce data input when calculating the intermediate images, an anisotropic sampling pattern, with pixels offset by at least one of a row and column, is used in a fashion adapted to a frequency content of the intermediate images.

34. A program, when executed by a computer device, adapted to perform the method of claim 33.

35. The device of claim 33, wherein the program is stored on a computer readable medium.

36. A device for producing images in spiral computed tomography from radiation detected from an object scanned with at least one conical beam, the method comprising:
means for calculating incomplete intermediate images; and
means for producing tomographic images using calculated the incomplete intermediate images, wherein to reduce data input when calculating the intermediate images, an anisotropic sampling pattern, with pixels offset by at least one of a row and column, is used in a fashion adapted to a frequency content of the intermediate images.
